(19) United States
(12) Patent Application Publication
(10) Pub. No.: US 2017/0013289 A1
(43) Pub. Date: Jan. 12, 2017

(54) METHODS AND SYSTEMS FOR FACILITATING MANAGEMENT OF RECORDED DIGITAL VIDEO

(71) Applicant: The DIRECTV Group, Inc., El Segundo, CA (US)

(72) Inventors: Kenji Nightingale, Los Angeles, CA (US); Randall M. Desmond, Lawndale, CA (US); Michael E. Depies, Lawndale, CA (US); Jonathan A. Thompson, Torrance, CA (US); Aaron L. Goldstein, Los Angeles, CA (US); Michael McBride, Burbank, CA (US)

(73) Assignee: THE DIRECTV GROUP, INC., El Segundo, CA (US)

(21) Appl. No.: 14/594,717

(22) Filed: Jan. 12, 2015

(51) Int. Cl. H04N 21/231; H04N 21/442; H04N 21/2387; H04N 21/41; H04N 21/472; H04N 21/6587; H04N 21/218; H04N 5/76; H04N 21/45; H04N 21/433

(52) U.S. Cl. CPC H04N 21/23113; H04N 21/4532; H04N 21/44222; H04N 21/2387; H04N 21/4334; H04N 21/47217; H04N 21/6587; H04N 21/2181; H04N 5/76; H04N 21/4135

(57) ABSTRACT

Embodiments described herein may provide for facilitating management of recorded digital video. An example method may involve a computing device (a) initiating playback of a recorded digital video file, (b) during playback of the recorded digital video file, receiving a request to stop playback, (c) responsive to receiving the request: (i) determining a stop point in the recorded digital video file and (ii) initiating a prompt asking whether or not to delete a portion of the recorded digital video file preceding the stop point, (d) responsive to the prompt, receiving a request to delete the portion preceding the stop point, and (e) responsively deleting the portion. In a further aspect, the computing device may also provide for display a visual representation of the stop point, an amount of the digital video file preceding the stop point, and an amount of the digital video file remaining after the stop point.

### BACKGROUND

Unless otherwise indicated herein, the materials described in this section are not prior art to the claims in this application and are not admitted to be prior art by inclusion in this section.

Digital television (TV) broadcasting systems such as satellite TV, cable TV, and Internet TV (e.g., Internet Protocol TV (IPTV)) may be implemented exclusively from one another or complementary to one another in order to provide a wide variety of high-quality content. Such digital systems provide various advantages over conventional analog systems because the video and audio content are stored in digital format. For example, such digital systems may facilitate manipulation of video and/or audio content and support a wider range of recording options for video and/or audio content (e.g., optical, hard disc, Random-Access Memory (RAM), etc.).

Satellite TV systems, for instance, typically broadcast content to a number of users simultaneously in a system. Satellite TV systems also offer subscription or pay-per-view access to broadcast content. Access is provided using signals broadcast over the satellite, and the user can then access the particular content.

Many satellite TV systems include a set-top box that contains a TV-tuner input and functions to receive and decode the satellite signals, thereby changing the satellite signals into a form of content that can then be displayed on a TV screen or other display device. A set-top box typically includes memory, and may take the form of (or include) a digital video recorder (DVR) or other recording means. A DVR may encode and store received video content in compressed digital formats such as MPEG-4 for future retrieval by a user. In this manner, users are able to view high quality video content at any desired time without deterioration of image quality. Other digital TV broadcasting systems may employ the use of set-top boxes and related technology as well.

### SUMMARY

A user may record digital videos to a set-top box, such as a DVR, but can record only a limited amount of digital video before the DVR reaches capacity. Accordingly, example embodiments may provide a user with the ability to delete a portion of a recorded digital video from the user's DVR, so that the user does not have to delete entire digital videos in order to make room on their DVR.

For example, while the user is watching a recorded digital video on television, the user may pause or otherwise stop watching the video in order to watch the remainder of the video at a later point in time. In such a scenario, the set-top box may determine a “stop point” at which the user has stopped watching the video, and provide the user with the option to delete, or “trim,” the portion of the video that the user has viewed thus far preceding the stop point. For instance, a message box may appear on the user's television screen overlaying the paused video, asking the user whether the user would like to keep or delete the portion of the video the user has watched. The user can thus select to delete the watched portion of the video from the user's DVR, thereby providing the user with more room to record other digital videos to the DVR. Other implementations and examples are also possible.

In one aspect, a method is provided. The method may include initiating, by a computing device, playback of a recorded digital video file. The method may also include, during playback of the recorded digital video file, receiving, at the computing device, a first input that indicates a request to stop playback. The method may further include, responsive to receiving the first input, the computing device: (i) determining a stop point in the recorded digital video file, where the stop point corresponds to receipt of the first input, and (ii) initiating a prompt to provide input that specifies whether or not to delete a portion of the recorded digital video file preceding the stop point. The method may still further include receiving, at the computing device, a second input that is responsive to the prompt, where the second input indicates a request to delete the portion of the recorded digital video file preceding the stop point. The method may yet still further include, responsive to receiving the second input, the computing device deleting the portion of the recorded digital video file preceding the stop point.

In another aspect, a system is provided. The system may include at least one processor, and data storage comprising instructions executable by the at least one processor to cause the system to perform operations. The operations may include initiating playback of a recorded digital video file. The operations may also include, during playback of the recorded digital video file, receiving a first input that indicates a request to stop playback. The operations may further include, responsive to receiving the first input: (i) determining a stop point in the recorded digital video file, where the stop point corresponds to receipt of the first input, and (ii) initiating a prompt to provide input that specifies whether or not to delete a portion of the recorded digital video file preceding the stop point. The operations may still further include receiving a second input that is responsive to the prompt, where the second input indicates a request to delete the portion of the recorded digital video file preceding the stop point. The operations may yet still further include, responsive to receiving the second input, deleting the portion of the recorded digital video file preceding the stop point.

In a further aspect, provided is a non-transitory computer-readable medium having stored thereon instructions executable by a computing device to cause the computing device to perform operations. The operations may include initiating playback of a recorded digital video file. The operations may also include, during playback of the recorded digital video file, receiving a first input that indicates a request to stop playback. The operations may further include, responsive to receiving the first input: (i) determining a stop point in the recorded digital video file, where the stop point corresponds to receipt of the first input, and (ii) initiating a prompt to provide input that specifies whether or not to delete a portion of the recorded digital video file preceding the stop point. The operations may still further include receiving a second input that is responsive to the prompt, where the second input indicates a request to delete the portion of the recorded digital video file preceding the stop point. The operations may yet still further include, responsive to receiving the second input, deleting the portion of the recorded digital video file preceding the stop point.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 is a simplified block diagram that illustrates a communication system, according to an example embodiment.

FIG. 2 is a functional block diagram that illustrates a computing device used in a communication system, according to an example embodiment.

FIG. 3 is a functional block diagram that illustrates a server used in a communication system, according to an example embodiment.

FIG. 4 is a flow chart depicting operations that can be carried out in accordance with the methods described herein.

FIG. 5 illustrates example operations being performed in accordance with the methods described herein.

FIG. 6 is a screenshot of a recorded television program overlaid by a user interface element, according to an example embodiment.

FIG. 7 is a screenshot of a user interface, according to an example embodiment.

FIG. 8 is a screenshot of another user interface, according to an example embodiment.

FIG. 9 is a screenshot of another user interface, according to an example embodiment.

FIG. 10 is a screenshot of another user interface, according to an example embodiment.

FIG. 11 is a screenshot of another user interface, according to an example embodiment.

FIG. 12 is a screenshot of another user interface, according to an example embodiment.

FIG. 13 is a screenshot of another user interface, according to an example embodiment.

### DETAILED DESCRIPTION

The following detailed description includes references to the accompanying figures. In the figures, similar symbols typically identify similar components, unless context dictates otherwise. The example embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein and illustrated in the figures can be arranged, substituted, combined, separated, and designed in a wide variety of different configurations, all of which are contemplated herein.

It should also be understood that while many example embodiments are primarily described herein with respect to satellite TV services, the disclosed methods and systems and associated operations could be implemented with respect to other digital TV broadcasting services, such as cable, Internet, and the like. Further, while the disclosed methods and associated operations are primarily described herein as performed by a computing device related to digital TV (e.g., a set-top box), the disclosed methods and associated operations could be performed by another type of computing device configured to manage digital content and provide such digital content to a user, such a mobile phone, tablet computer, laptop computer, and the like.

Moreover, the term “playback” may be used herein to refer to a user or other entity reproducing previously recorded digital audio and/or digital video (i.e., digital audio/video files). By way of example, a user watching a recorded digital video can be considered playback. As a related example, the user “stopping” playback of the recorded digital video may take various forms. For instance, stopping playback may refer to the user temporarily stopping, or “pausing,” playback. In another instance, stopping playback may refer to the user stopping playback for a longer period of time, such as when the user exists playback of the recorded digital video altogether, perhaps to return to a menu in which the user can select a different recorded digital video to watch, for instance. Other examples are possible as well.

### I. OVERVIEW

Embodiments are described herein that may help to facilitate management of recorded digital video. Over time, a user may record segments of content broadcasted on TV (“TV programs”) such as sports events, movies, serialized TV shows, and the like to their DVR or other digital content recording device for future viewing. However, DVR storage capacity may be limited. Thus, users can record only a certain amount of programs to their DVR before running out of capacity and having to delete recorded programs in order to make more room in storage. Some current DVRs may only provide the user with the option to delete entire recorded programs from the user's DVR, which may not be desirable in some scenarios.

Accordingly, in an example embodiment, a user can be provided with the ability to delete a portion of a recorded program from the user's DVR, while leaving the remaining portion on the DVR's storage for later viewing. For instance, the user may begin playback of recorded program, but may not complete watching the recorded program. Once the user has stopped playback, a computing device (such as a set-top box, DVR, or other device configured to manage a set-top box or DVR) may determine a stop point in the program at which the user stopped playback. The computing device may then display to the user an option to delete, or “trim,” the portion of the program that the user has viewed thus far up to the stop point. For instance, a message box may appear on the user's television screen overlaying the paused program, asking the user whether the user would like to keep or delete the portion of the program the user has watched.

If the user selects to delete the portion, the computing device may then remove the portion from memory of the DVR, leaving the remaining portion of the program still saved to the DVR. Consequently, the deleted portion may no longer take up storage space in the DVR, thus increasing storage space. Furthermore, when the user resumes playback of the trimmed program, the playback may begin at the determined stop point. On the other hand, if the user selects not to delete the portion, the computing device may not remove the portion from memory of the DVR. The user can thus view the portion again, if desired. Furthermore, the next time the user stops playback of the program, the computing device may determine a new stop point and may again provide the user with the option to delete the portion of the program that the user has viewed thus far up to the new stop point.

In some scenarios, when a user has recorded many programs to the DVR (e.g., episodes of a TV series), and has watched only a portion of a particular episode, that episode may nevertheless appear to the user in a manner that incorrectly indicates to the user that the user has completed watching the episode. For instance, the text of the episode's title may be “greyed out” in the DVR menu. In such scenarios, it may be more difficult for the user to determine if they have completed watching the episode, or if they have only watched a portion of the episode. Thus, in addition to alerting the user that they have completed watching a program or haven't watched a program at all, it may be useful to alert the user that they have watched only a portion of a particular episode, so that the user can select an appropriate episode to watch (e.g., an unfinished older episode, or an unwatched newer episode).

Accordingly, in a further embodiment, the computing device may provide a user with a visual representation of how much of a particular recorded program the user has watched. To facilitate this, the computing device may keep track of (i) whether a particular recorded program has been watched, and (ii) if the program has been watched, an amount of the program that has been watched, based on the stop point at which the user stopped playback of the program. In addition, the computing device may provide for display (on the user's television, smartphone, etc.) a navigable user interface listing programs that the user has recorded. When the user has watched only a portion of a program, the computing device may display the program as greyed out, as discussed above, and may also display to the user a graphic indicating where the current stop point is located with respect to the total duration the program. For example, the computing device may calculate a percentage of the program that the user has watched based on the stop point (e.g., by dividing the amount of the program watched by the total duration of the program, then multiplying by one hundred), and display text representative of the percentage next to the greyed out program in the navigable program list. Additionally or alternatively, the computing device may display a progress bar indicating how much of the program the user has watched.

It should be understood that the above examples are provided for illustrative purposes, and should not be construed as limiting.

### II. EXAMPLE COMMUNICATION SYSTEM AND ASSOCIATED DEVICES

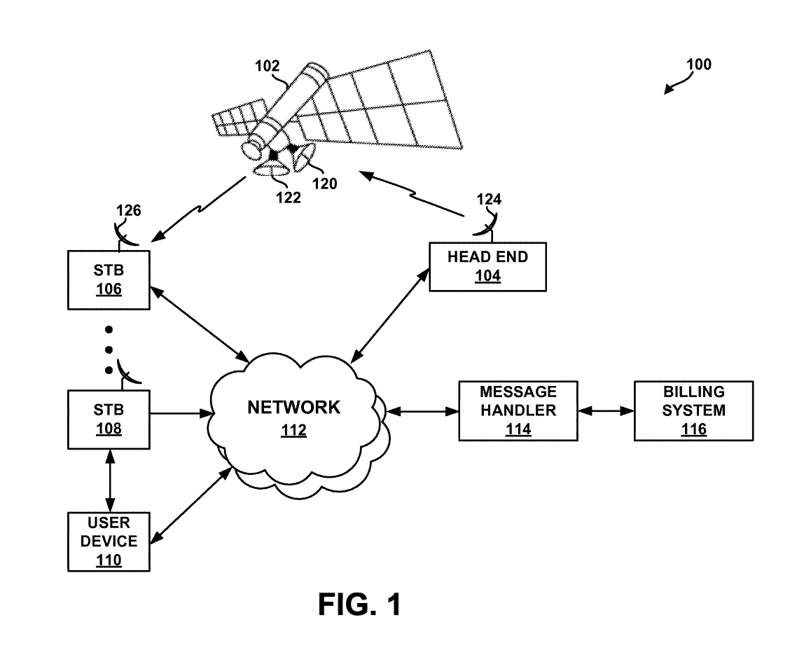

Referring now to the figures, FIG. 1 is a simplified block diagram that illustrates a communication system 100 in which embodiments of the disclosed methods and entities can be implemented. The communication system 100 may include a satellite 102, a head end 104, one or more set-top boxes 106, 108, one or more user devices 110, one or more networks 112, and one or more servers, such as a message handler server 114, a billing system server 116, a customer service center server 118, and a call placement system server 120. Other devices may also be included in the communication system 100. It should be understood that, although not illustrated, multiple satellites, head ends, servers, and other components might be included in the communication system 100. Moreover, while multiple components are illustrated separately, it should be understood that one or more of the components may be implemented as distributed components.

Satellite 102 may include one or more antennas 120, 122 configured to send and receive digital or analog signals to one or more devices in the communication system 100. For instance, satellite 102 may include a first antenna 120 configured to receive data via an uplink signal from a device, such as head end 104. Satellite 102 may also include a second antenna 122 that may transmit data via a downlink signal to a receiving device. The receiving device may be a mobile device or a stationary device. Set-top boxes 106, 108 or user device 110 may be a mobile device or a stationary device. In some examples, a single antenna may be used to receive data via an uplink signal and transmit data via a downlink signal. Other examples are also possible.

Head end 104 may include a transmitting antenna 124 for communicating data using one or more signals. For instance, transmitting antenna 124 may send signals to the antenna 120 at satellite 102. Satellite 102 may in turn send downlink signals to a receiving device, such as set-top box 106. In another instance, head end 104 may communicate data to set-top box 106 via a network 112. Network 112 may be representative of one or more types of networks, such as a public switched telephone network, the Internet, a mobile telephone network, or other type of network.

Set-top boxes 106, 108 are examples of receiving devices configured to receive data from satellite 102 or network 112. For example, set-top box 106 may include or be connected to an antenna 126 for receiving downlink signals from antenna 122. Set-top box 106 may also include one or more components structured and arranged to receive signals from network 112. The type, content, and number of signals received by set-top box 106 may vary. For instance, the signals may be media signals that may include video or audio signals. Data sent via the media signals may include content, program data, images, requests, or the like. Accordingly, set-top boxes 106, 108 may each comprise a DVR or other device for recording and storing digital content or other such data. Other examples are also possible.

In some examples, set-top boxes 106, 108 may be interconnected with one or more devices in the communication system 100 via a local network (not illustrated). The local network, which may be a wired network or wireless network, may be used to interconnect set-top boxes 106, 108 within a household, multi-dwelling unit, or commercial building. The local network may also allow for multi-room viewing of content stored on a first set-top box (such as set-top box 106) and communicated to a second set-top box (such as set-top box 108) through the local network. The stored content can comprise content a set-top box 106 receives from antenna 126.

User device 110 may include a variety of stationary or mobile computing devices. For example, user device 110 may include a landline telephone, cellular telephone, smartphone, personal computer, laptop computer, tablet computer, personal digital assistant (PDA), portable media player, or other computing device now known or later developed. User device 110 may be configured to send or receive data in a variety of ways. For example, user device 110 may receive downlink signals from antenna 122. In another example, user device 110 may send or receive signals from network 112. In yet another example, user device 110 may send or receive signals from one or more devices in the communication system 100. For instance, user device 110 may send or receive signals from set-top boxes 106, 108 via network 112. Other examples are also possible.

In some examples, user device 110 may be a mobile computing device such as a smartphone, tablet computer, or laptop computer that can be used to perform various operations in accordance with satellite TV services. For instance, user device 110 may support mobile applications that allow a user to remotely access and manage features and services that the user has subscribed to. By way of example, mobile applications may enable the user to remotely view TV programs on user device 110, and/or may enable the user to remotely schedule, add, delete, edit, or otherwise manage DVR recordings from user device 110. To facilitate such operations in practice, user device 110 may be linked communicatively, via a local network or other type of wired or wireless network, with one or more set-top boxes owned and maintained by a user, such as set-top box 108 as shown in FIG. 1. Other examples are possible as well.

Communication system 100 may also include one or more servers, such as a message handler server 114. Message handler server 114 may include an enterprise service bus (ESB), and be configured to receive data from one or more devices via network 112. For example, message handler server 114 may receive signals from set-top box 106 via network 112. In some instances, the signals may include one or more requests for information relating to a subscriber or a service available at set-top box 106. However, other instances are also possible. After the message handler server 114 receives data, the message handler server 114 may process or communicate the received data to one or more other servers or components in the communication system 100.

Message handler server 114 may communicate with billing system server 116. Billing system server 116 may keep track of subscriptions that a user is subscribed to, pay-per-view purchases, and on-demand purchases, and include information that may be used for purposes of calculating, creating, and maintaining bills. For example, the information may include account information including a customer or subscriber identifier (ID), such as a name, login, or unique subscriber ID, associated with a subscriber. The account information may also include: (i) location data for the subscriber (e.g., a subscriber address, city, state, zip code, county, country, etc.), (ii) service area information (e.g., a geographical region where a service is available), (iii) phone number data (e.g., one or more phone numbers associated with the subscriber), (iv) language information (e.g., one or more spoken or written languages, such as English, Spanish, French, Chinese, etc., which may be used to communicate with the subscriber), (v) a subscription-level indicator, such as an indication that the customer has a basic, intermediate, or premium subscription, for instance, (vi) a start date or end date of the subscription, (vii) the duration of time (e.g., the number of years) that the subscriber has had a subscription, (viii) current balance data, or (ix) outstanding balance data, among other possibilities.

In some examples, billing system server 116 may receive one or more information requests from one or more servers and respond to the request by sending the requested information to the requesting or designated server. For instance, billing system server 116 may receive an information request for subscriber phone numbers from message handler server 114. Billing system server 116 may respond to the information request by sending the requested subscriber information to message handler server 114. Upon receipt, message handler server 114 may send the received phone number information to set-top box 106. Other examples are also possible.

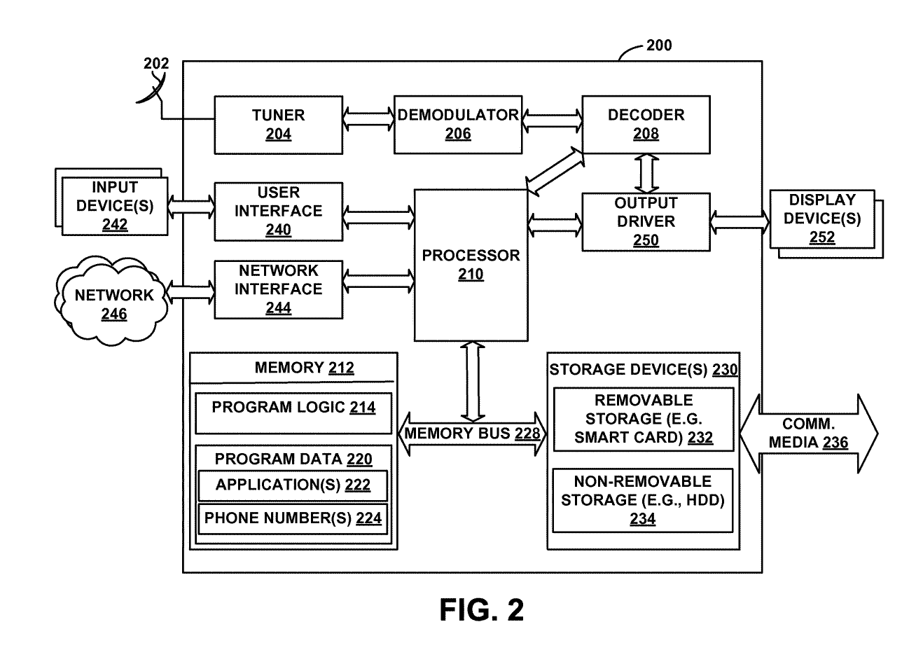

FIG. 2 is a functional block diagram that illustrates a computing device 200 used in a communication system in accordance with embodiments described herein. Computing device 200 may take a variety of forms. For example, computing device 200 may comprise or be arranged as a set-top box (such as set-top boxes 106, 108 of FIG. 1), and may further comprise a DVR or other digital content recording device. The set-top box may be used for television or other media. As another example, computing device 200 may comprise or be arranged as a landline or cellular telephone, smartphone, personal computer, laptop computer, tablet computer, personal digital assistant (PDA), portable media player, or other computing device now known or later developed.

Computing device 200 may include an antenna 202, a tuner 204, a demodulator 206, a decoder 208, a processor 210, a memory 212, one or more storage devices 230, a user interface 240, a network interface 244, and an output driver 250. Although, a particular configuration of computing device 200 is illustrated, the configuration is merely representative of various possible receiving devices. For example, although only one tuner 204, one demodulator 206, and one decoder 208 are illustrated, multiple tuners, demodulators, or decoders may be provided within computing device 200. The components described in FIG. 2 may be communicatively linked by a system bus, network, or other connection mechanism.

Antenna 202 may be one of a number of different types of antennas that may include one or more low noise blocks downconverters (LNB) associated therewith. For instance, antenna 202 may be a single antenna for receiving signals from a satellite (such as satellite 102 of FIG. 1), network (such as network 112 of FIG. 1), or terrestrial source. In another instance, antenna 202 may include multiple antennas for different orbital slots. In yet another instance, signals and other items described as being received by antenna 202 can be received by network interface 244 by way of a coaxial cable or other communication link. In that regard, one or more signals or items received at network interface 244 can be forwarded to tuner 204.

Tuner 204 may receive a signal from antenna 202. The signal may be a media signal that may include video or audio signals. The signal may also include a television signal. The content of the signal may vary based on the type of signal. For example, the content may include television programming content, program guide data or other types of data. Tuner 204 may then communicate the signal to demodulator 206.

Demodulator 206 may receive the signal and demodulate the signal to form a demodulated signal. Decoder 208 may decode the demodulated signal to form a decoded signal or decoded data. The decoded signal may then be sent to processor 210 or output driver 250. However, other examples are also possible.

Processor 210 may be any type of processor, such as a microprocessor, a microcontroller, a digital signal processor (DSP), multicore processor, etc. Processor 210 may be used to coordinate or control tuner 204, demodulator 206, decoder 208, and any other components of computing device 200 that may or may not be illustrated in FIG. 2. In some implementations, processor 210 may include an internal memory controller (not illustrated). Yet other implementations may include a separate memory controller that can be used with processor 210.

A memory bus 228 can be used for communicating between the processor 210 and memory 212. Memory 212 may be any suitable type of memory. For example, memory 212 may include a non-transitory computer-readable medium, for example, such as computer-readable media that stores data for short periods of time like solid-state memory, flash drives, register memory, processor cache and RAM. The computer-readable medium may also or alternatively include non-transitory media, such as secondary or persistent long-term storage, like read only memory (ROM), optical or magnetic disks, compact disc read only memory (CD-ROM), for example. The computer-readable medium may also be any other volatile or non-volatile storage system. The computer-readable medium may, for example, be considered a computer-readable storage medium, a tangible storage device, or other article of manufacture.

Memory 212 may include program logic 214 and program data 220. Program logic 214 may include programming instructions, such as computer executable or logic-implemented instructions. In some examples, the programming instructions may be provided or otherwise obtainable in a downloadable format, such as via network 246 (which may be illustrated as network 112 in FIG. 1). Program data 220 may include program information that can be directed to various data types. For instance, program data 220 may include one or more applications 222 that may execute one or more algorithms arranged to provide input components of computing device 200, in accordance with the present disclosure. Program data 220 may also include data (such as phone numbers 224 or customer account information) that may be stored in memory 212 at computing device 200.

In some implementations, memory 212 may be distributed between one or more locations. For example, at least a portion of memory 212 may reside within processor 210. In another example, all or part of memory 212 may reside on a storage device 230. Storage device 230 may include removable storage devices, non-removable storage devices, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), memory cards, smart cards and tape drives to name a few. Computer storage media can include volatile and nonvolatile, transitory, non-transitory, removable and non-removable media implemented in any method or technology for storage of information, such as computer-readable instructions, data structures, program modules, or other data.

Computing device 200 may also include a user interface 240 that is configured to allow a customer to interact with computing device 200 via one or more input devices 242. Examples of input device 242 may include a remote control (or more simply, a remote), keyboard, a computer mouse, one or more push buttons, a touch screen, a smartphone, a tablet computer, a voice activated interface, or the like. Input device 242 may be used, for example, to select a channel, select information, change the volume, change the display appearance, or other functions using user interface 240. The process of making a selection with input device 242 may take a variety of forms, such as an action by a customer.

Computing device 200 may include network interface 244 for communicating data through one or more networks 246. Network interface 244 may take a variety of forms. For example, network interface 244 may be a WiFi, WiMax, WiMax mobile, data over cable service interface specification (DOCSIS), wireless, cellular, or other types of interfaces. Moreover, network interface 244 may use a variety of protocols for communicating via the network 246. For instance, network interface 244 may communicate using Ethernet, a Transmission Control Protocol/Internet Protocol (TCP/IP), a hypertext transfer protocol (HTTP), or some other protocol.

Computing device 200 may be coupled to a display 252. Display 252 may be a television, monitor, or other device configured to display images. The images may be video, graphics, text, or any variety of other visual representations. In some examples, the display 252 may include an audio output, such as a loudspeaker, to generate sound waves from media signals received by display 252.

Display 252 may communicate with an output driver 250 within computing device 200 to facilitate communication between computing device 200 and display 252. In some implementations, output driver 250 may work in conjunction with a graphics processing unit (not illustrated), which can be configured to communicate with display device 252. Output driver 250 can communicate with display device 252 by a high-definition multiple interface (HDMI) cable, a coaxial cable, some other wired communication link, or wirelessly.

In some examples, computing device 200 may communicate directly or indirectly with one or more additional devices using a communication media 236. A communication connection is one example of a communication media 236. Communication media 236 may be embodied by computer-readable instructions, data structures, program modules, or other data in a modulated data signal, such as a carrier wave or other transport mechanism. The communication media 236 may also include wireless, optical, or other information delivery media. A modulated data signal can be a signal that has one or more of its characteristics set or changed in such a manner to encode information in the signal. By way of example, and not limitation, communication media 236 can include wired media such as a wired network or direct-wired connection, and wireless media such as acoustic, radio frequency (RF), infrared (IR) or other wireless media. The communication may include a cellular or cellular data connection, a satellite data connection, etc.

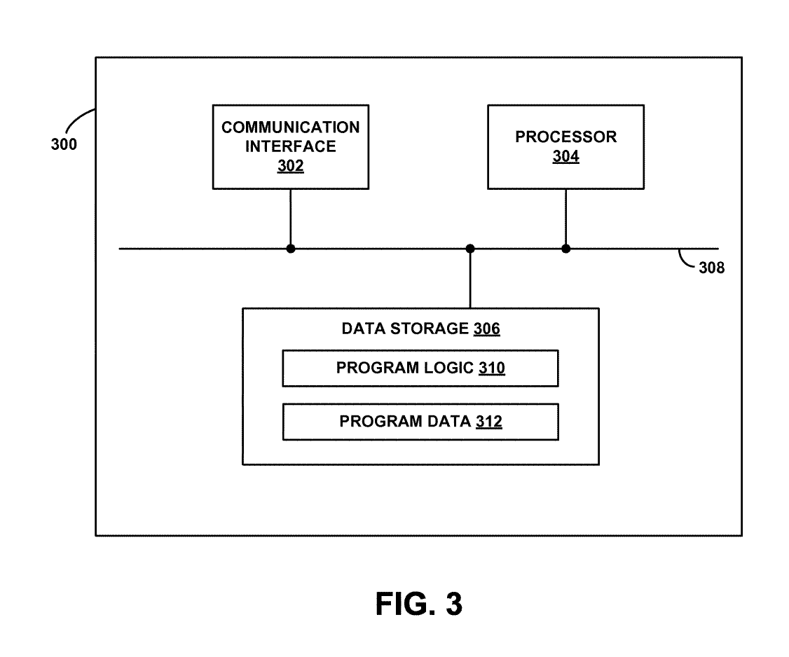

FIG. 3 is a functional block diagram that illustrates a server 300 used in a communication system in accordance with embodiments described herein. As shown, server 300 may include a communication interface 302, a processor 304, and a data storage 306, all of which may be communicatively linked together by a system bus, network, or one or more other connection mechanisms 308. Although not shown, server 300 may also include other components, such as external storage. It should also be understood that the configuration or functionality of server 300 may be distributed or subdivided between a plurality of entities, such as multiple servers. Further, it should be understood that some of the functions described herein may be carried out by an entity other than a server.

In server 300, the communication interface 302 may comprise one or more structures, and associated equipment, for receiving data from one or more sources and distributing data to a group of one or more destinations. For instance, communication interface 302 may be configured to receive a request from one or more entities (such as a set-top box) and add the request in a queue based on data associated with the request. The communication interface 302 may also be configured to provide for a communication to occur once the request is de-queued or otherwise processed.

Processor 304 may comprise one or more processors, such as general-purpose processors (e.g., a microprocessor), special-purpose processors (e.g., an application-specific integrated circuit (ASIC) or digital-signal processor (DSP)), programmable-logic devices (e.g., a field programmable gate array (FPGA)), or any other processor components now known or later developed. Processor 304 may be integrated in whole or in part with other components of server 300.

Data storage 306 may be a non-transitory computer-readable medium. For example, data storage 306 may take the form of one or more volatile or non-volatile storage components, such as magnetic, optical, or organic storage components, integrated in whole or in part with a processor 306. As further shown, data storage 306 may include program logic 310 or program data 312. Program logic 310 may include, for example, machine language instructions executable by processor 304 to carry out various functions, such as the functionality of the methods and systems described herein. Program data 312 may include one or more types of data deemed suitable for a given implementation. For example, program data 312 may include program information that can be directed to various data types (such as queues). Program data 312 may also include data (such as digital video content and/or database tables relating to customer information) that may be stored in memory.

In some embodiments, server 300 may be configured to manage multiple set-top boxes or other computing devices associated with a particular network. For instance, a user may have multiple set-top boxes in the user's home, and server 300 may relay messages from one set-top box to another, and/or may relay messages transmitted from a computing device such as a smartphone to one or more set-top boxes in the user's local network. As such, server 300 may propagate changes the user has made to settings of (and/or recordings made to) of one set-top box to one or more other set-top boxes in the local network. Server 300 may be configured to perform other operations as well.

### III. ILLUSTRATIVE FUNCTIONALITY

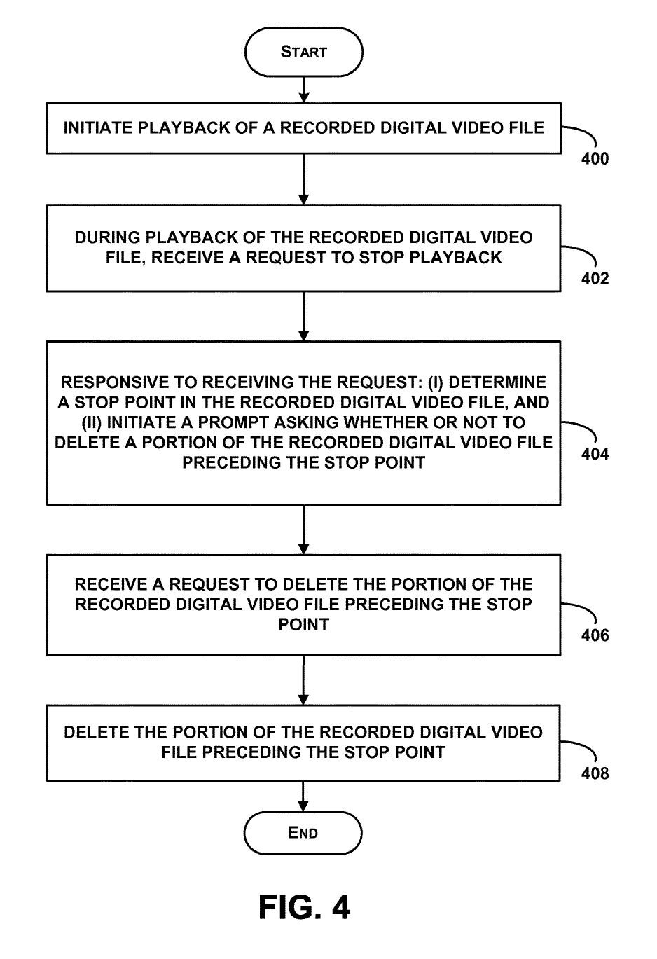

FIG. 4 is a flow chart of an example method that may be included in or performed by the communication system to facilitate implementation of the methods described herein. For purposes of illustration, the method in FIG. 4 is described as being implemented by a computing device (such as set-top box 106 in FIG. 1, computing device 200 in FIG. 2, or server 300 in FIG. 3) comprising a DVR. However, the method could be implemented by and/or used with other devices (e.g., smartphones or other computing devices by which a user can manage the DVR) or may be performed by a combination of any components of such devices. In addition, the method could be carried out in accordance with the systems and aspects illustrated in FIG. 4. The method may include one or more operations, or actions as illustrated by one or more of blocks 400-408. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for the method and other processes and methods disclosed herein, the flowchart shows operation of one possible implementation of present implementations. In this regard, each block may represent a module, a segment, or a portion of program code, which includes one or more instructions executable by one or more processors for implementing specific logical operations or steps in the process. The program code may be stored on any type of memory described above, such as a non-transitory computer readable medium that includes non-transitory media, for instance.

Furthermore, for the method and other processes and methods disclosed herein, each block in FIG. 4 may represent circuitry that is wired to perform the specific logical operations in the process.

At block 400, the method involves the set-top box initiating playback of a recorded digital video file. The recorded digital video file may be a TV program (e.g., a serial TV show, sports event, or the like) or other type of digital video file. In some embodiments, playback of the recorded digital video file may occur at a normal speed, a fast-forwarded speed, or may involve alternating between normal speed and fast-forwarded speed.

At block 402, the method involves, during playback of the recorded digital video file, the set-top box receiving a request to stop playback. In some embodiments, the set-top box may receive the request by receiving a first input that indicates the request. In one example, the set-top box may receive the first input by way of the user pushing a pause button or a stop button on a remote controller, touchscreen, keyboard, or other device that is in communication with the set-top box. In another example, the set-top box may receive the first input by way of the user powering off the set-top box, television, and/or other display device on which the user is watching the program. The set-top box may receive the first input in other manners as well.

At block 404, the method involves, responsive to receiving the request, the set-top box (i) determining a stop point in the recorded digital video file, and (ii) initiating a prompt asking whether or not to delete a portion of the recorded digital video file preceding the stop point. Further, in some embodiments, the set-top box may store the stop point in memory so that the user can resume playback at the stop point. In addition to or alternative to the set-top box initiating a prompt asking whether or not to delete the portion of the recorded digital video file preceding the stop point, the set-top box may initiate a prompt asking whether or not to delete a portion of the recorded digital video following the stop point (i.e., the remaining portion of the digital video file).

The set-top box may initiate the prompt in various ways. In some embodiments, the set-top box may provide for display a graphical user interface (GUI) element that includes the prompt. In particular, the GUI element may include text prompting the user to make a selection between deleting the portion and not deleting the portion. The user can interact with the GUI element by way of an input device such as a remote controller, touchscreen, keyboard, or the like, in order to make the selection. The GUI element may overlay at least part of a still frame of the recorded digital video file on the display. For instance, when the user pauses playback of a particular program, the GUI element may appear on a screen as a pop-up message window overlaying the current frame of the program at the stop point.

In further embodiments, when the user stops playback of the program by exiting playback and returning to the DVR menu, for instance, the set-top box may provide the GUI element for display overlaying at least part of the DVR menu screen. In still further embodiments, when the user powers off the set-top box during playback of the program, the set-top box may provide the GUI element for display at some point after the set-top box has been powered back on, such as when the user returns to the DVR menu and/or upon the user resuming playback of the program.

In yet further embodiments, the set-top box may provide the GUI element for display on a computing device different from the device on which the user is watching the program at issue. For example, although the program may appear on a television screen, the set-top box may transmit instructions to the user's smartphone for the smartphone to display the GUI element. The smartphone may display the GUI element via an application running on the smartphone that is associated with the user's satellite service, by way of which the user can remotely manage the user's DVR. The user may then select whether to delete the portion using the GUI element on the smartphone. In other embodiments, the GUI element may not include an interactive element for enabling the user to delete the portion of the program. Rather, the set-top box may transmit a text message or email message to the user's smartphone notifying the user where the current stop point is, as well as how much playback time has elapsed and/or how much playback time remains in the program at issue. In a similar example, the text message or email message may include a link to either a website or an application, and the user can then use the website or application to select whether or not to delete the portion of the program.

In some embodiments, the set-top box may determine the stop point and/or initiate the prompt only when certain criteria are met. For example, the set-top box may prompt the user to delete the portion of the program only when the amount of storage space on the DVR is below a predetermined threshold (e.g., when less than 10% of the storage space is available). As another example, the set-top box may prompt the user to delete the portion of the program only when the current duration of playback exceeds a predetermined threshold (e.g., when the user has watched over three minutes of the program). As another example, the set-top box may prompt the user to delete the portion of the program only when the program at issue is a particular type of program (e.g., an episode of a TV series, a movie, a sports program, etc.). As another example, the set-top box may prompt the user to delete the portion of the program based on the name of the program (e.g., the set-top box may prompt the user for “TV Show 1,” but not for “TV Show 2”). As yet another example, the set-top box may prompt the user to delete the portion of the program only when the total duration of the program at issue exceeds a predetermined duration. In such embodiments, the set-top box may determine that one or more of the criteria noted above has been met, and responsively determine the stop point and/or initiate the prompt.

In further embodiments, the set-top box may enable the user to adjust various settings and parameters relating to the criteria noted above. In one example the user may toggle one or more of the criteria on or off. In another, more general example, the user may set prompting on or off (e.g., the set-top box can automatically delete the portion of the program preceding the stop point without prompting the user). In still another example, the user may adjust one or more of the thresholds discussed above. In yet another example, the user may adjust the timing and/or frequency at which the user will be prompted to delete watched portions of programs. Such settings and parameters can be adjusted per program, adjusted per groups of programs (e.g., a TV series), or adjusted universally for all recorded programs.

At block 406, the method involves the set-top box receiving a request to delete the portion of the digital recorded video file preceding the stop point. Such a deletion request may be received in response to the initiation of the prompt. Similar to the request to stop playback, the set-top box may receive the request to delete the portion of the program by receiving a second input that indicates the request. For instance, the set-top box may receive the second input by way of the user pushing a button (on a remote controller, touchscreen, etc.) that corresponds to a selection to delete the portion of the program.

At block 408, the method involves the set-top box deleting the portion of the recorded digital video file preceding the stop point. The set-top box may delete the portion in response to receiving the request to delete the portion.

In some embodiments, the set-top box may delete the portion of the program at issue from the DVR immediately and automatically upon the set-top box receiving the request. In other embodiments, the set-top box may flag the portion for deletion and determine a future point in time at which the set-top box will delete the program from the DVR. Then, at the determined future point in time, the set-top box may either (i) delete the program from the DVR automatically or (ii) initiate another prompt to the user asking whether or not the user still wishes to delete the portion of the program. In one example, the set-top box may flag the portion for deletion and may automatically delete the portion at a predetermined future point in time if the user does not resume playback of the portion of the program, or resume playback of any other portion of the program, before that predetermined future point in time. In another example, the user may instruct the set-top box to automatically delete the portion of the program at a user-specified future point in time, or may instruct the set-top box to prompt the user again at the user-specified point in time so that the user can decide later on whether or not the user would like to delete the portion of the program. In accordance with such embodiments, the set-top box may maintain a queue in which multiple programs can be stored for deletion, each program having a corresponding future time at which the set-top box will delete the program.

In further embodiments, the set-top box may permit multiple different users to each maintain user-profiles through which the users can collectively access and manage programs recorded to the set-top box's DVR. As such, multiple users may be permitted to trim a single program stored on the DVR (e.g., if one user trims the program, the program will be trimmed for all other users as well). Alternatively, for each set-top box in a network of set-top boxes, a copy of the program may be stored on the set-top box's DVR and may be accessible only by authorized users. As such, each user may store their own copy of the program that only they can trim.

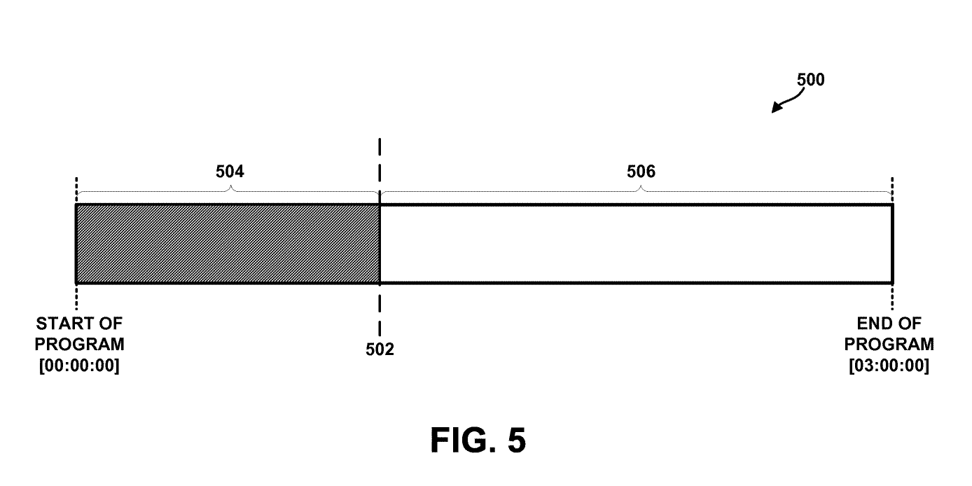

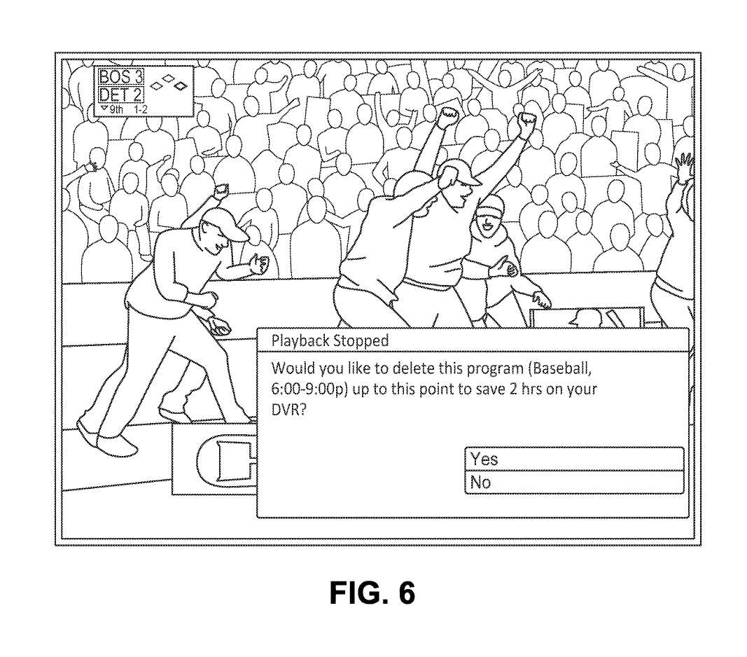

In an example scenario illustrated by FIG. 5 and FIG. 6, a user may initiate playback of a program, such as a baseball game, that the user has recorded to the user's DVR and that has a duration of three hours. As shown in FIG. 5, the program at issue, in its entirety, is represented by bar 500. At some point during playback of the program, the user may pause playback, and the set-top box may responsively determine the stop point 502. The set-top box may then provide the user with the option to delete portion 504 of the program (i.e., the portion preceding the stop point 502), and thereby leave only portion 506 (i.e., the portion following the stop point 502) stored on the DVR. As shown in FIG. 6, the set-top box may provide the user with this option by providing for display a GUI element overlaying part of a still frame of the program at the stop point 502. The GUI element may specify various types of information, such as (i) a notification that the user has stopped playback, (ii) the title of the program at issue (e.g., “Baseball”), (iii) the total duration of the program, and (iv) a notification of how much time (or storage space, in other embodiments) the user could save on their DVR by deleting the portion of the program up to the stop point 502, among other possibilities. Furthermore, the GUI element may include options “Yes” and “No,” which the user can select in order to trim portion 504 or not to trim portion 504, respectively. Other examples are possible as well.

In some embodiments, the set-top box may be configured to operate in two or more different modes relating to the feature of trimming programs discussed above. For example, a first mode that the set-top box may be configured to operate in is a mode where the set-top box does not trim programs and never provides the user with the option to trim programs. As another example, a second mode that the set-top box may be configured to operate in is a mode where the set-top box stores stop points and asks the user if the user would like to trip the program at issue. As yet another example, a third mode that the set-top box may be configured to operate in is a mode where the set-top box automatically trims the program at issue when playback is stopped, without first asking the user whether the user would like to trim the program. In such embodiments, the set-top box may be configured to automatically set itself to operate in one or more of these modes based on various criteria being met, such as one or more of the criterion described above. For instance, the set-top box may set itself to operate in the third mode (automatically trimming without asking the user) when the amount of storage space on the DVR is below a predetermined threshold (e.g., when less than 5% of storage space is available). Such a predetermined threshold that is used as a basis for determining which mode the set-top box should set itself to operate in may be the same as or different from the storage space threshold described above. Further, each mode may be associated with relative criteria (e.g., a predetermined storage space threshold) different from the criteria to which other modes are associated, and the set-top box may set itself to operate in that mode when the relative criteria are met. Alternatively, the set-top box may provide the user with the ability to manually set the set-top box to operate in one or more of the modes.

In some embodiments, when a user has watched at least a portion of the program, the set-top box may flag the program in memory as having been watched. For instance, the set-top box may not flag the program as having been watched until the user has watched at least a minimum amount of time of the program (e.g., thirty seconds, one minute, etc.). The set-top box may enable the user to set and adjust such a predetermined threshold amount of time.

In further embodiments, the set-top box may display an indicator to the user that the program has been watched. For instance, the set-top box may display an indicator to the user that the program has been completely watched. By way of example, the text of the program's title may be displayed in a different color than other programs listed in the DVR menu (e.g., greyed out). As another example, a background or icon associated with the program may be displayed in a different color than other programs. The set-top box may visually indicate that the user has completed watching the program in other manners as well.

As noted, once a user stops playback of a program, the set-top box may determine a current stop point that corresponds to where in the program the user was when the user stopped playback. The set-top box may use the stop point as a basis for determining the amount of time of the program that the user has watched and/or the amount of time of the program that the user has yet to watch. Using such a determination, in yet further embodiments, the set-top box may provide for display a “progress indicator” to show the user that a program has been at least partially watched (i.e., at least a portion of playback of the program has been completed). The set-top box may provide the progress indicator for display after any amount of time of the program has been watched, or may display the progress indicator only when the user has watched at least a minimum amount of time of the program.

The progress indicator may take the form of a visual representation of the stop point, the amount of time of the program the user has watched thus far, and/or the amount of time of the program the user has yet to watch, among other possibilities. For example, the progress indicator may take the form of: elapsed and/or remaining time of playback (e.g., “[00:15:00],” “15 min, 0 sec”), elapsed and/or remaining percentage of the program (e.g., “25%”) (the percentage being based on an amount of time remaining in the program relative to a total length of time of the program), a color-coded graphic (e.g., a colored box where red corresponds to less than 25% of program watched, yellow corresponds to 25%-50% of program watched, etc.), color-coded text (e.g., the title text of the program changes color), color-coded background of text (e.g., the background behind the title text of the program changes color), a graphic of an analog clock displaying elapsed and/or remaining time, a pop-up window alert notifying a user about how much of the program the user has watched, and other possibilities. In other examples, the progress indicator may take the form of a progress graphic divided into at least two exclusive portions including a first portion and a second portion, the first portion being a visual representation of the amount of time elapsed during playback of the program preceding the stop point, and the second portion being a visual representation of the amount of time remaining in the program, beginning at the stop point. For instance, the progress indicator may take the form of a progress bar divided into sections for time elapsed and time remaining, and/or a pie chart divided into sectors for time elapsed and time remaining.

Further, one or more of such progress indicators may also be used to visually represent a portion of the program that the user has already trimmed or currently has the option to trim (e.g., a colored progress bar with a grey area representative of a portion of the program that the user has trimmed). It should be understood that, in some embodiments, multiple progress indicators may be used in combination, such as a percentage and corresponding progress bar, a color-coded progress bar, or the letters of the program's title text serving as a progress bar, among other possibilities.

In further embodiments, the set-top box may use the type of program as a basis for determining the progress indicator and/or determining whether to provide the progress indicator for display. For example, the set-top box may provide the progress indicator for display in response to a determination that the program at issue is an episode of a TV series or otherwise a part of a TV series. As another example, the set-top box may not provide the progress indicator for display in response to a determination that the program at issue is a movie. In still further embodiments, the set-top box may make a determination of whether any other programs stored in the DVR are related to the program at issue, and then use that determination as a basis for determining the progress indicator and/or determining whether to provide the progress indicator for display. For example, the set-top box may provide the progress indicator for display in response to a determination that (i) the program at issue is an episode of a TV series and (ii) there are other episodes of the TV series recorded to the DVR. As another example, the set-top box may provide the progress indicator for display in response to a determination that (i) the program at issue is a movie and (ii) at least one sequel to the movie or other program related to the movie is recorded to the DVR. In such embodiments, the user may be able to configure the set-top box to determine and/or provide the progress indicator based on types of programs that the user specifies. Other examples are possible as well.

As noted, the set-top box may permit multiple different users to each maintain user-profiles through which the users can collectively access and manage programs recorded to the set-top box's DVR. Thus, in addition to notifying a user of how much of a program the user has watched, it may be useful for that user to be notified of how much of the same program other users have watched. Accordingly, when multiple users have watched the same program, the set-top box may determine and store respective stop points associated with each user-profile. The set-top box may then provide multiple progress indicators for display, each associated with the respective stop points. For instance, the set-top box may provide for display a first progress bar associated with a first user-profile, and a second progress bar associated with a second user-profile. The set-top box may provide such progress indicators for display simultaneously or non-simultaneously. Further, the set-top box may provide such progress indicators for display proximate to one another, or non-proximate to one another.

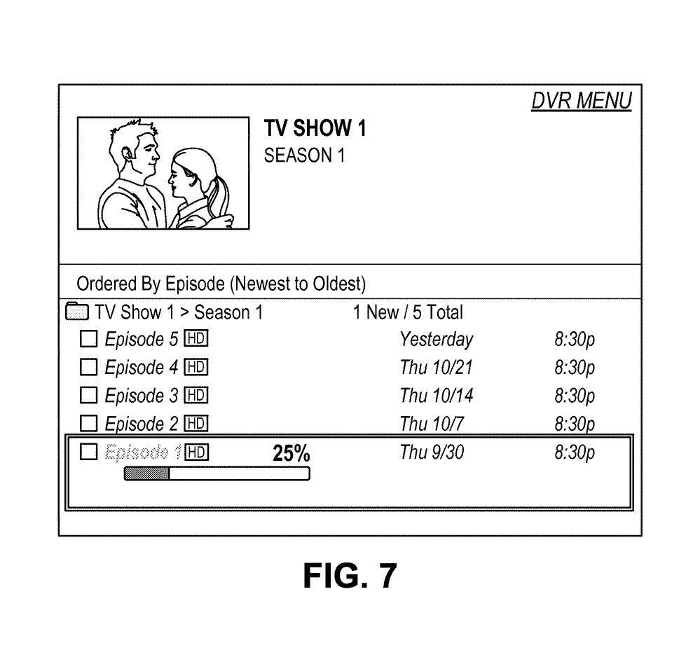

Moreover, the progress indicators discussed above may be provided for display as part of a GUI. In particular, the progress indicators may take the form of GUI elements that are displayed as part of a GUI that is a navigable list of recorded digital video files including the recorded digital video file at issue. In one example, the GUI may take the form of a navigable DVR menu listing programs that the user has previously recorded, as discussed above. FIGS. 7-13 illustrate screenshots of a navigable DVR menu in which the set-top box can provide various types of progress indicators. As shown, the menu includes five recorded episodes of a TV show (labeled “Episodes 1-5” of “TV Show 1”). The menu may be displayed on a screen of a television, for instance, and a user may navigate the menu using a remote controller device such as a television controller, DVR controller, or other type of controller. The menu can also be displayed on a screen of a computing device, such as a laptop computer, tablet computer, or smartphone. The user can sign in to the user's account on the computing device (provided that the computing device is authorized the computing device is authorized by the user) and use the menu to remotely manage programs that the user has recorded.

Furthermore, the set-top box may provide each authorized user with the ability to adjust when and how the set-top box will determine and/or display the progress indicator. For instance, one user may configure the set-top box to display progress bars for only movies listed in the menu, while another user may configure the set-top box to display a color-coded graphic for all types of programs listed in the menu. Other examples are possible as well.

As shown in FIG. 7, the menu includes a percentage appearing to the right of the title text of Episode 1. The menu further includes a progress bar that corresponds to the percentage. Both the percentage and the progress bar indicate to the user that the user has completed 25% of playback of Episode 1. In particular, the progress bar is divided into two sections: a first section that is shaded and corresponds to the 25% of playback that the user has completed of Episode 1, and a second section that is unshaded and corresponds to the remaining 75% of playback that the user has yet to complete of Episode 1.

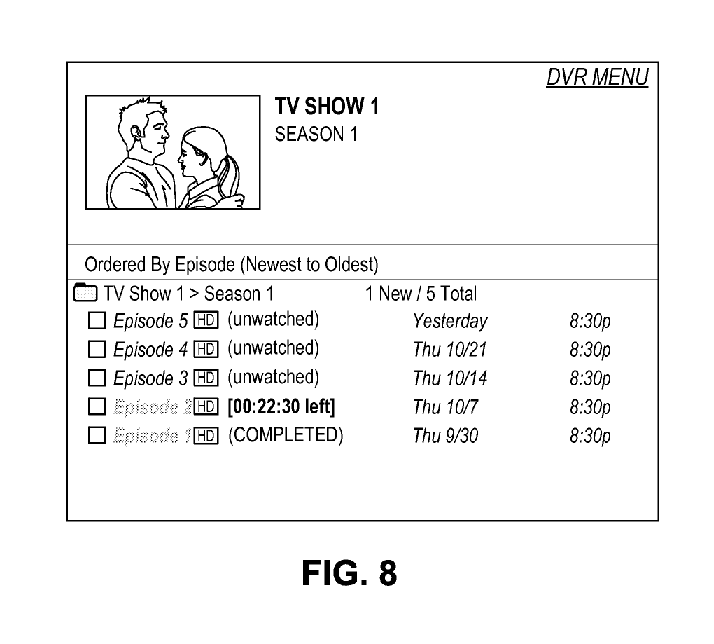

As shown in FIG. 8, both Episode 1 and Episode 2 are greyed out, indicating to the user that the user has completed at least a portion of playback of each of Episodes 1 and 2. Further, the menu includes the text “COMPLETED” to the right of the title text of Episode 1 to indicate to the user that the user has completed playback of Episode 1. Still further, the menu includes the amount of time remaining in Episode 2, in brackets, to the right of the title text of Episode 2, indicating to the user that the user has not completed the last twenty two minutes and thirty seconds of playback of Episode 2. In a similar example not shown in FIG. 8, the menu could include the amount of time that the user has watched thus far, rather than the amount of time remaining. The menu could also include a different progress indicator to show the user that the user has completed playback of Episode 1 (e.g., “[00:00:00 left]”).

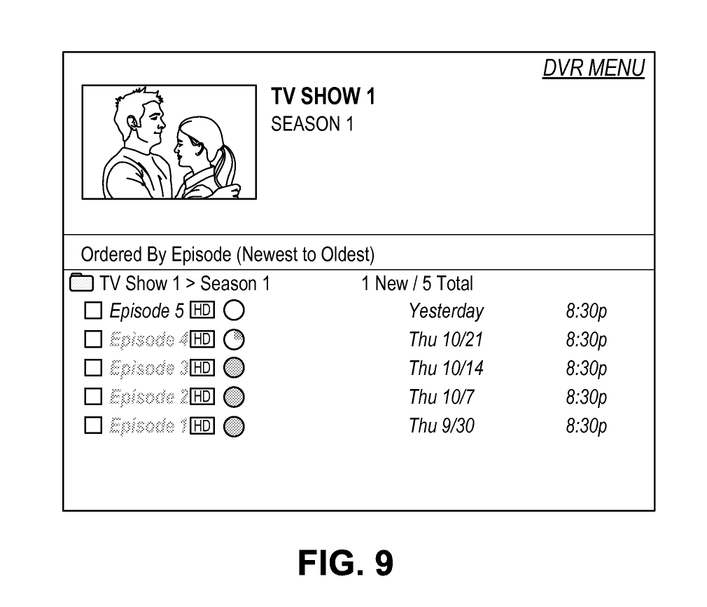

As shown in FIG. 9, Episodes 1-4 are each greyed out, indicating to the user that the user has completed at least a portion of playback of each of Episodes 1-4. In addition, to the right of the title text of each episode, the menu includes respective pie charts. For a given episode, the shaded sector of the pie chart corresponds to the percentage of playback of the given episode that the user has completed, and the unshaded sector corresponds to the percentage of playback of the given episode that the user has not yet completed. For instance, as shown, the pie charts of Episodes 1-3 are completely shaded, thus indicating to the user that the user has completed playback of each of Episodes 1-3. Further, the pie chart of Episode 4 is 25% shaded, thus indicating to the user that the user has completed only 25% of playback of Episode 4. Still further, the pie chart of Episode 5 is 100% unshaded, thus indicating to the user that playback of Episode 5 has not yet been initiated.

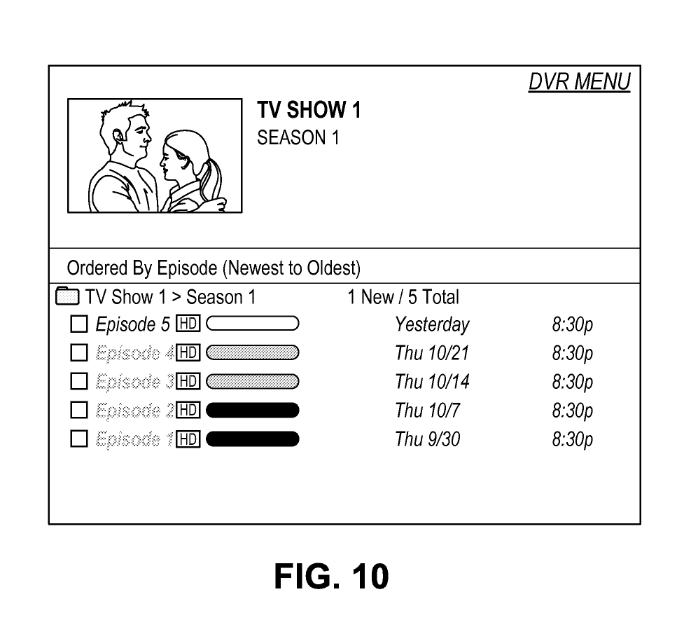

As shown in FIG. 10, Episodes 1-4 are each greyed out, indicating to the user that the user has completed at least a portion of playback of each of Episodes 1-4. In addition, to the right of the title text of each episode, the menu includes respective bars with three different types of shading. Although FIG. 10 is illustrated in black and white, the three different shades may represent a different color, where each color corresponds to whether the user has (i) completed playback of a given episode, (ii) partially completed playback of the given episode, or (iii) not yet initiated playback of the given episode. For instance, the darkest shades of the bars for Episodes 1 and 2 may represent the color green, which may indicate to the user that the user has completed playback of Episodes 1 and 2. Further, the grey bars for Episodes 4 and 5 may represent the color yellow, which may indicate to the user that the user has partially completed playback of each of Episodes 3 and 4. Still further, the white bar for Episode 5 may represent the color red, which may indicate to the user that the user has not yet initiated playback of Episode 5. In related examples, the menu could include more or less than three colors, each corresponding to different amounts or ranges of playback completeness. Although not shown, the menu could also include a color-coding legend specifying to which amount or range of playback completeness each colors corresponds.

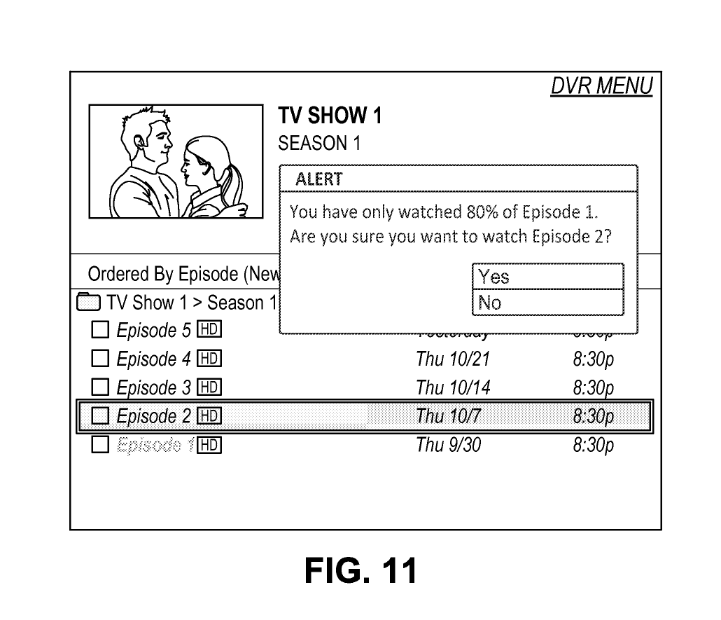

As shown in FIG. 11, Episode 1 is greyed out, indicating to the user that the user has completed at least a portion of playback of Episode 1. In addition, the menu also includes a pop-up message alerting the user that the user has completed only 80% of playback of Episode 1 and prompting the user to select whether the user would still like to initiate playback of Episode 2. In this scenario, such a pop-up message could be displayed to the user in response to the user selecting a given episode for playback when the user has not yet completed playback of at least one episode that precedes the given episode. Alternatively, the pop-up message could be displayed to the user in response to the user selecting a given episode for playback when the user has completed over a predetermined threshold amount of playback of at least one episode that precedes the given episode.

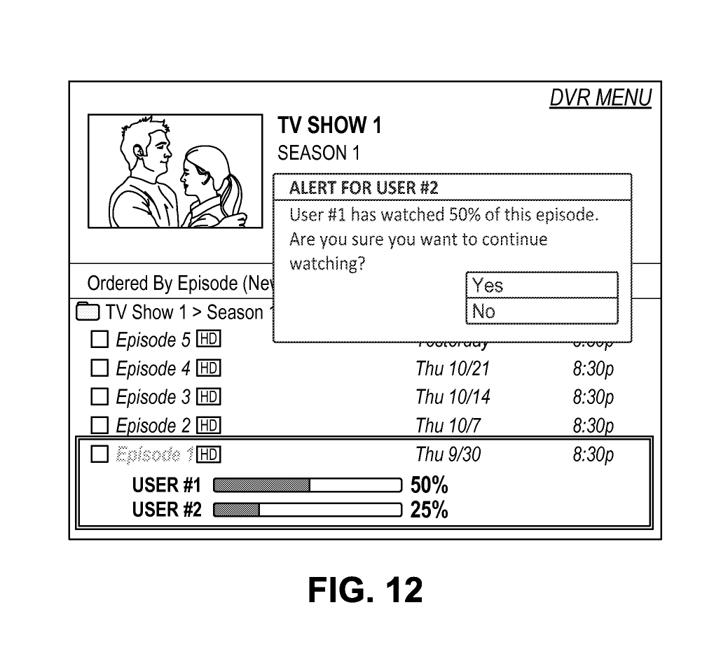

As shown in FIG. 12, below the title text of Episode 1, the menu includes include two progress bars associated with Episode 1: a first progress bar indicative of a percentage of playback of Episode 1 that a first user with access to the DVR (e.g., User #1) has completed, and a second progress bar indicative of a percentage of playback of Episode 1 that a second, different user with access to the DVR (e.g., User #2) has completed. For instance, as shown, the top progress bar (and corresponding percentage to the right of the top progress bar) indicate that User #1 has completed 50% of playback of Episode 1, whereas the bottom progress bar (and corresponding percentage to the right of the bottom progress bar) indicate that User #2 has completed 25% of playback of Episode 1. Further, the menu includes a pop-up message alerting the current user who is accessing the DVR (User #2, in this case) that another user (User #1 in this case) has completed 50% of playback of Episode 1. The pop-up message also includes a prompt for User #2 to select whether User #2 would like to continue playback of Episode 1.

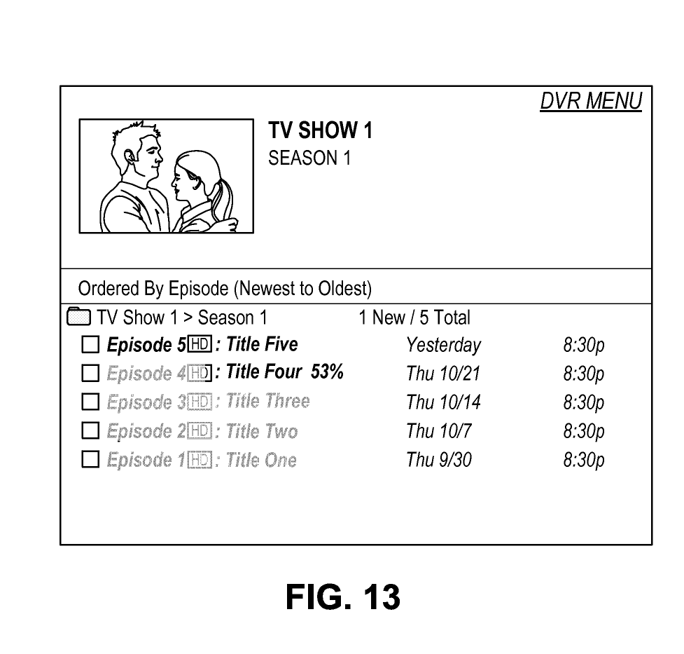

As shown in FIG. 13, for each program, the program's title text is greyed out in proportion to the amount of the program that the user has watched and/or trimmed. For instance, Episodes 1-3 are completely greyed out, indicating to the user that the user has completed playback of each of Episodes 1-3. Further, no portion of Episode 5 is greyed out, indicating to the user that the user has not yet initiated playback of Episode 5. Still further, Episode 4 is partially greyed out, indicating to the user that the user has completed a portion of playback of Episode 4 proportional to the amount of Episode 4's title text that is greyed out. In particular, 53% of Episode 4 is greyed out, indicating to the user that the user has completed 53% of playback of Episode 4, and text appears to the right of Episode 4 representative of the percentage. Alternatively, the 53% could indicate that the user has 53% of playback of the program remaining. As noted, in other embodiments, the greyed out portions of the programs' title texts could indicate the portion of each program that the user has trimmed. For instance, the percentage 53% could indicate that the user has trimmed 53% of Episode 4 from memory of the DVR. The DVR menu could also display the greyed out texts of Episodes 1-3 to indicate to the user that the user has completed watching previous episodes of TV Show 1 and had previously deleted/trimmed such programs from the DVR.

### IV. CONCLUSION

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

1. A method comprising:
initiating, by a computing device, playback of a recorded digital video file for a first user-profile from a plurality of distinct user-profiles that are associated with a television service account, wherein the television service account authorizes at least the first and a second of the plurality of distinct user-profiles to access the recorded digital video file;
during the playback of the recorded digital video file, receiving a first input that indicates to stop the playback of the recorded digital video file;
responsive to receiving the first input, determining a first stop point in the recorded digital video file, wherein the first stop point corresponds to receipt of the first input;
at a point in time after receipt of the first input, subsequently initiating, by the computing device, playback of the recorded digital video file for the second user-profile from the plurality of distinct user-profiles;
during the subsequent playback of the recorded digital video file for the second user-profile, receiving a second input that indicates to stop the subsequent playback of the recorded digital video file for the second user-profile;
responsive to receiving the second input:
(i) determining a second stop point in the recorded digital video file, wherein the stop point corresponds to receipt of the second input, and
(ii) causing a graphic display to display a first progress indicator corresponding to a portion of the recorded digital video file preceding the second stop point that was played back during the subsequent playback of the recorded digital video file for the second user-profile;
receiving a third input that indicates to delete the portion of the recorded digital video file preceding the second stop point; and
responsive to receiving the third input indicating to delete the portion of the recorded digital video file preceding the second stop point, causing the graphic display to display both: (a) a second progress indicator corresponding to a portion of the recorded digital video file preceding the first stop point that was played back during the playback of the recorded digital video file for the first user-profile, and (b) a prompt requesting input indicating whether or not to delete the portion of the recorded digital video file preceding the second stop point given that the first stop point in the recorded digital video file also exists.

2. The method of claim 1, wherein the prompt, when displayed, overlays at least part of a still frame of the recorded digital video at the second stop point.

3. (canceled)

4. The method of claim 1, wherein the first progress indicator comprises an amount of time remaining in the recorded digital video file after the second stop point.

5. The method of claim 1, wherein the first progress indicator comprises a percentage of the recorded digital video file remaining after the second stop point.

6. The method of claim 1, wherein the first progress indicator comprises a duration of the portion of the recorded digital video file preceding the second stop point.

7. The method of claim 1, further comprising:
the computing device storing the first stop point to the first user-profile associated with the television service account; and
the computing device storing the second stop point to the second user-profile associated with the television service account.

8-9. (canceled)

10. The method of claim 1, further comprising:
making a determination that an amount of storage space in memory of the computing device is less than a predetermined threshold,
wherein causing the graphic display to display both the second progress indicator and the prompt is further responsive to the determination that the amount of storage space in the memory of the computing device is less than the predetermined threshold.

11. A system comprising:
at least one processor; and
data storage comprising instructions executable by the at least one processor to cause the system to perform operations comprising:
initiating playback of a recorded digital video file for a first user-profile from a plurality of distinct user-profiles that are associated with a television service account, wherein the television service account authorizes at least the first and a second of the plurality of distinct user-profiles to access the recorded digital video file;
during the playback of the recorded digital video file, receiving a first input that indicates to stop the playback of the recorded digital video file;
responsive to receiving the first input, determining a first stop point in the recorded digital video file, wherein the first stop point corresponds to receipt of the first input;
at a point in time after receipt of the first input, subsequently initiating playback of the recorded digital video file for the second user-profile from the plurality of distinct user-profiles;
during the subsequent playback of the recorded digital video file for the second user-profile, receiving a second input that indicates to stop the subsequent playback of the recorded digital video file for the second user-profile;
responsive to receiving the second input:
(i) determining a second stop point in the recorded digital video file, wherein the stop point corresponds to receipt of the second input, and
(ii) causing a graphic display to display a first progress indicator corresponding to a portion of the recorded digital video file preceding the second stop point that was played back during the subsequent playback of the recorded digital video file for the second user-profile;
receiving a third input that indicates to delete the portion of the recorded digital video file preceding the second stop point; and
responsive to receiving the third input indicating to delete the portion of the recorded digital video file preceding the second stop point, causing the graphic display to display both: (a) a second progress indicator corresponding to a portion of the recorded digital video file preceding the first stop point that was played back during the playback of the recorded digital video file for the first user-profile, and (b) a prompt requesting input indicating whether or not to delete the portion of the recorded digital video file preceding the second stop point given that the first stop point in the recorded digital video file also exists.

12. The system of claim 11, further comprising a computing device, wherein the recorded digital video file is representative of a digital video that has been recorded to the computing device and that is stored in memory at the computing device.

13. The system of claim 11, further comprising a computing device and a remote computing device different from the computing device, wherein the recorded digital video file is representative of a digital video that has been recorded to the remote computing device and that is stored in memory at the remote computing device.

14. The system of claim 13, wherein the remote computing device is a set-top box comprising a digital video recorder (DVR), and
wherein the computing device deleting the portion of the recorded digital video that precedes the stop point comprises the computing device controlling the set-top box to delete the recorded digital video file from memory of the DVR.

15-16. (canceled)

17. The system of claim 11, wherein playback of the recorded digital video file comprises playing the portion of the recorded digital video file at a normal speed.

18. The system of claim 11, wherein playback of the recorded digital video file comprises fast forwarding through the portion of the recorded digital video file.

19. A non-transitory computer-readable medium having stored thereon instructions executable by a computing device to cause the computing device to perform operations comprising:
initiating playback of a recorded digital video file for a first user-profile from a plurality of distinct user-profiles that are associated with a television service account, wherein the television service account authorizes at least the first and a second of the plurality of distinct user-profiles to access the recorded digital video file;
during the playback of the recorded digital video file, receiving a first input that indicates to stop the playback of the recorded digital video file;
responsive to receiving the first input, determining a first stop point in the recorded digital video file, wherein the first stop point corresponds to receipt of the first input;
at a point in time after receipt of the first input, subsequently initiating playback of the recorded digital video file for the second user-profile from the plurality of distinct user-profiles;
during the subsequent playback of the recorded digital video file for the second user-profile, receiving a second input that indicates to stop the subsequent playback of the recorded digital video file for the second user-profile;
responsive to receiving the second input:
(i) determining a second stop point in the recorded digital video file, wherein the stop point corresponds to receipt of the second input, and
(ii) causing a graphic display to display a first progress indicator corresponding to a portion of the recorded digital video file preceding the second stop point that was played back during the subsequent playback of the recorded digital video file for the second user-profile;
receiving a third input that indicates to delete the portion of the recorded digital video file preceding the second stop point; and
responsive to receiving the third input indicating to delete the portion of the recorded digital video file preceding the second stop point, causing the graphic display to display both: (a) a second progress indicator corresponding to a portion of the recorded digital video file preceding the first stop point that was played back during the playback of the recorded digital video file for the first user-profile, and (b) a prompt requesting input indicating whether or not to delete the portion of the recorded digital video file preceding the second stop point given that the first stop point in the recorded digital video file also exists.

20. The non-transitory computer-readable medium of claim 19, wherein the operations further comprise:
determining an amount of time elapsed during the subsequent playback of the recorded digital video file preceding the second stop point; and
making a determination of whether the determined amount of time elapsed during the subsequent playback of the recorded digital video file preceding the second stop point exceeds a predetermined threshold,
wherein causing the graphic display to display both the second progress indicator and the prompt is further responsive to the determination being that the determined amount of time exceeds the predetermined threshold.

21. The non-transitory computer-readable medium of claim 19, wherein the operations further comprise:
making a determination of whether the recorded digital video file is one of a series of other digital video programs related to the recorded digital video file,
wherein causing the graphic display to display both the second progress indicator and the prompt is further responsive to the determination being that the recorded digital video file is one of the series of other digital video programs related to the recorded digital video file.

22. The non-transitory computer-readable medium of claim 19, wherein the computing device is configured to operate in at least two modes, wherein the at least two modes include two or more of: (i) a first mode where the computing device does not cause the graphic display to display both second progress indicator and the prompt, and does not delete the portion, (ii) a second mode where the computing device causes the graphic display to display both the second progress indicator and the prompt, and (iii) a third mode where the computing device automatically deletes the portion of the recorded digital video preceding the second stop point without causing the graphic display to display both the second progress indicator and the prompt.

23. The non-transitory computer-readable medium of claim 22, wherein the operations further comprise:
determining an amount of storage space in memory of the computing device; and
setting the computing device to operate in one of the at least two modes based on a comparison between the determined amount of storage space and one or more storage-space thresholds, wherein each of the at least two modes corresponds to one of the one or more storage-space thresholds.

24. The non-transitory computer-readable medium of claim 23, wherein setting the computing device to operate in one of the at least two modes based on the comparison between the determined amount of storage space and the one or more storage-space thresholds comprises setting the computing device to operate in the first mode based on the comparison indicating that the determined amount of storage space exceeds a high storage-space threshold of the one or more storage-space thresholds.

25. The non-transitory computer-readable medium of claim 23, wherein setting the computing device to operate in one of the at least two modes based on the comparison between the determined amount of storage space and the one or more storage-space thresholds comprises setting the computing device to operate in the second mode based on the comparison indicating that the determined amount of storage space falls below a low storage-space threshold of the one or more storage-space thresholds.

26. The non-transitory computer-readable medium of claim 23, wherein setting the computing device to operate in one of the at least two modes based on the comparison between the determined amount of storage space and the one or more storage-space thresholds comprises setting the computing device to operate in the third mode based on the comparison indicating that the determined amount of storage space falls below a low storage-space threshold of the one or more storage-space thresholds.

27. (canceled)

28. The system of claim 11, the operations further comprising:
receiving a fourth input that is responsive to the prompt, the fourth input indicating to delete the portion of the recorded digital video file preceding the second stop point given that the first stop point in the recorded digital video file also exists;
responsive to receiving the fourth input, deleting the portion of the recorded digital video file preceding the second stop point.

29. The system of claim 28, wherein deleting the portion of the recorded digital video file preceding the second stop point responsive to receiving the fourth input comprises:
upon receipt of the fourth input, immediately deleting the portion of the recorded digital video file preceding the second stop point.

30. The system of claim 28, wherein deleting the portion of the recorded digital video file preceding the second stop point responsive to receiving the fourth input comprises:
responsive to receiving the fourth input, determining a future time for the portion of the recorded digital video file to be deleted; and
deleting the portion of the recorded digital video file at the determined future time.
